(19) United States
(12) Patent Application Publication
(10) Pub. No.: US 2020/0299046 A1
(43) Pub. Date: Sep. 24, 2020

(54) Multi-Pack Consisting Of A Dimensionally Stable Receiving Container And A Number Of Deformable Cleaning Agent Sachets, And Method For Providing A Multi-Pack

(71) Applicant: Henkel AG & Co. KGaA, Duesseldorf (DE)

(72) Inventors: Frank Meier, Duesseldorf (DE); Matthias Sunder, Duesseldorf (DE); Uwe Trebbe, Duesseldorf (DE); Piotr Hamerlak, Langenfeld (DE)

(21) Appl. No.: 16/898,530

(22) Filed: Jun. 11, 2020

Related U.S. Application Data
(63) Continuation of application No. PCT/EP2018/084229, filed on Dec. 10, 2018.

(30) Foreign Application Priority Data
Dec. 12, 2017 (DE) 102017222529.7

(51) Int. Cl. B65D 75/30; B65D 77/06; B65B 35/50; B65B 61/06; C11D 17/04

(52) U.S. Cl. CPC B65D 75/30; B65D 77/06; C11D 17/045; B65B 61/06; B65B 35/50

(57) ABSTRACT

A multi-pack which consists of a dimensionally stable receiving container and a number of deformable cleaning agent sachets that are received in the receiving container, the cleaning agent sachets being arranged in the receiving container in like orientation. The invention also relates to an associated method for providing a multi-pack.

### FIELD OF THE INVENTION

The present invention relates to a multi-pack which consists of a dimensionally stable receiving container and a number of deformable cleaning agent sachets. It further relates to a method for providing such a multi-pack.

### BACKGROUND OF THE INVENTION

Cleaning agents, such as machine washing agents, are known which are packaged in sachets for single application. Such sachets are received and stored, for example, in a dimensionally stable receiving container.

However, as has been found, particularly for deformable cleaning agent sachets which are received in dimensionally stable receiving containers, there is a risk of damaging the sachets during transport, storage and removal since such sachets often have stiff edges or corners which can puncture adjacent sachets.

In addition, in the course of producing such sachets, during a random discharge of freshly produced and therefore particularly easily deformable cleaning agent sachets into a multi-pack, numerous sachets are severely deformed and pressed together. Due to this intimate contact, a plurality of sachets can become entangled, or adhesion between adjacent sachets can occur, making it difficult for the consumer to separate the sachets again. In addition, it is desirable that the consumer should not handle severely deformed sachets, which are often unattractive in their outer appearance. Severely deformed sachets would, in principle, require several minutes or hours after being removed from a multi-pack in order to return to their original shape after manufacture. However, since the consumer generally uses the cleaning agent sachets immediately for cleaning, for example placing them directly in a domestic appliance, they often cannot experience the original product design at all due to sachet deformations.

### BRIEF SUMMARY OF THE INVENTION

The problem addressed by the present invention is that of providing a multi-pack consisting of a dimensionally stable receiving container and a number of deformable cleaning agent sachets, for which multi-pack the risk of damage to the sachets is reduced. Furthermore, an economical method for providing such a multi-pack is to be provided.

This problem is solved by a multi-pack which consists of a dimensionally stable receiving container and a number of deformable cleaning agent sachets. The sachets are received in the receiving container, wherein they are arranged in the receiving container in like orientation in an automated manner.

Advantageous embodiments and developments of the invention are found in the appended claims.

In principle, cleaning agents within the generic sachets are understood for the purposes of this invention to mean all cleaning substances and cleaning preparations, such as those used in commercial and private environments in order to clean surfaces or objects. In particular, all cleaning substances and cleaning preparations are included which are used in the domestic environment, especially cleaning substances and cleaning preparations which are used within domestic appliances, such as washing machines for laundry, tumble dryers, combined washer dryers, dishwashers or similar machines. For the purposes of the present invention, the term “cleaning agent” is also to be understood, among other things, to mean generally cleaning-active substances, cleaning or washing aids, additives, machine cleaners, fragrances, dyes and other active ingredients facilitating the washing or cleaning process. However, the use of such cleaning agents is not limited to the use in the above-mentioned domestic appliances.

The sachets according to the invention enclose the cleaning agent received therein in the sense of an outer packaging. In this case, the sachet can either be removed before the actual application of the cleaning agent or consist of a suitable material which itself dissolves during the cleaning application and thus releases the cleaning agent. For example, the sachet consists of a suitable water-soluble material.

According to one aspect of the invention, a multi-pack is provided which consists of a dimensionally stable receiving container and a number of deformable cleaning agent sachets which are received in the receiving container, the cleaning agent sachets being arranged in the receiving container in like orientation.

An arrangement in like orientation within the receiving container is understood here and below to mean that the individual cleaning agent sachets are aligned parallel to one another so as to have mutually corresponding sides or axes of symmetry. This means that the upper faces and lower faces of the cleaning agent sachets have like orientation, specifically are oriented so as to be aligned parallel to one another, for example the sachet upper faces being in each case aligned facing upward within the receiving container. In addition, the lateral edge regions of the sachets within the receiving container are in each case oriented identically. For example, the right-hand edge regions of all sachets within the receiving container point to the same side wall of the receiving container.

The multi-pack advantageously allows a particularly high packing density compared with a randomly oriented arrangement of the individual sachets. In addition, the risk of damage caused by adjacent sachets is reduced because, in particular for pillow-shaped sachets, hard and stiff edge regions of a sachet no longer come into contact with easily-damaged surfaces of an adjacent sachet, but rather with its equally robust edge regions.

Furthermore, the multi-pack has the advantage that any possible imprints on a fixed surface of each cleaning agent sachet containing, for example, product information, always immediately catch the eye of a user when the cleaning agent sachets are each arranged with this surface toward the removal opening of the receiving container.

According to an advantageous embodiment, the cleaning agent sachets have at least one upper face and one lower face opposite the upper face, which faces form the main surfaces of the cleaning agent sachet, the cleaning agent sachets being aligned in the receiving container such that the upper faces and lower faces are aligned parallel to a base of the receiving container. This embodiment has the advantage that very frequently-used pillow-shaped sachets, which are particularly susceptible to damage due to their two large, exposed main surfaces and their stiff edge regions, can be safely received in the receiving container and are largely protected from damage caused by edge regions of adjacent sachets.

A base of the receiving container is understood to mean the side of the receiving container on which said container typically stands on a support during use.

According to a preferred embodiment, in a pillow-shaped sachet of this kind, the cleaning agent is received between a first film and a second film in order to form the cleaning agent sachets, the first film in each case forming the upper face and the second film in each case forming the lower face of the cleaning agent sachets. In addition, the films are designed to be self-dissolving in the course of the cleaning application, i.e. the films typically consist of a water-soluble material. Furthermore, the first film and the second film are in each case interconnected, for example welded together, in the peripheral edge regions of the cleaning agent sachets. Individual films of such a cleaning agent sachet can also be connected by means of sealing or adhesive bonding (for example using water) and application of pressure and optionally an increase in temperature. Often, various film-connecting methods are combined, e.g. wetting inside the first film and pressing onto the second film by means of a heated roller.

The two films can each be similar films. However, it is also possible that, although the same materials are used for the first film and second film, they have different thicknesses. For example, the film forming the lower faces can be thicker than the film forming the upper faces. According to another embodiment, films of different materials can also be used.

Such cleaning agent sachets consisting of two interconnected films are particularly economical to produce.

According to one embodiment, the cleaning agent sachets are formed by at least one water-soluble film. Such water-soluble films have the advantage that they do not have to be dissolved by the cleaning agent before the metering of the cleaning agent sachet, for example into a domestic appliance, such as a washing machine. Rather, they themselves dissolve during the washing process. The handling behavior is thus particularly good.

Such films can have thicknesses between 20 and 150 μm, in particular between 35 and 100 μm. Due to their thickness, such water-soluble films are relatively easy to damage such that the proposed like orientation of the cleaning agent sachets in the receiving container is particularly advantageous for said films.

The cleaning agent sachets can in particular be designed as multi-chamber sachets in which a plurality of different components of the cleaning agent are arranged separately from one another in chambers of the cleaning agent sachets.

According to one aspect of the invention, a method is given for providing the described multi-pack, the method comprising providing a dimensionally stable receiving container and providing a number of deformable cleaning agent sachets. Furthermore, the method comprises picking up and stacking the cleaning agent sachets in like orientation in the receiving container in an automated manner.

In order to pick up and stack the cleaning agent sachets in the receiving container in an automated manner, pick-and-place methods which are known in principle can be employed using robots. The cleaning agent sachets can be transported by means of gripper arms or vacuum suction heads of such a manufacturing robot. When using vacuum suction heads, the cleaning agent sachet is vacuum-sucked on the upper face, transported, and then discharged into the container by switching off the vacuum.

According to a further embodiment, the step of providing the number of deformable cleaning agent sachets comprises encasing a number of cleaning agent portions with a common film, for which, for example, it is possible to proceed as follows: firstly, the second film is placed on a molding tool and filled with the cleaning agent portions. subsequently, the first film is placed on and the sachet chamber formed thereby is closed by means of a molding tool.

The providing step further comprises subsequently cutting the film to separate the cleaning agent sachets, the automated picking up and stacking of the cleaning agent sachets in the receiving container taking place immediately after the separation of the cleaning agent sachets.

Picking up the cleaning agent sachets immediately after the separation is understood here and below to mean that the separated cleaning agent sachets are not again picked up and placed for the purpose of intermediate storage before the stacking in the receiving container.

The method has the advantage that it is particularly economical and time-saving.

### BRIEF DESCRIPTION OF THE DRAWINGS

The invention is explained in greater detail below with the aid of exemplary embodiments and with reference to the accompanying schematic drawings, in which:

FIG. 1 is a sectional view of a multi-pack according to an embodiment of the invention;

FIG. 2 is a plan view of a cleaning agent sachet for a multi-pack according to an embodiment of the invention; and

FIG. 3 is a schematic sectional view of a laser cutting process for separating the cleaning agent sachet according to FIG. 2.

### DETAILED DESCRIPTION OF THE INVENTION

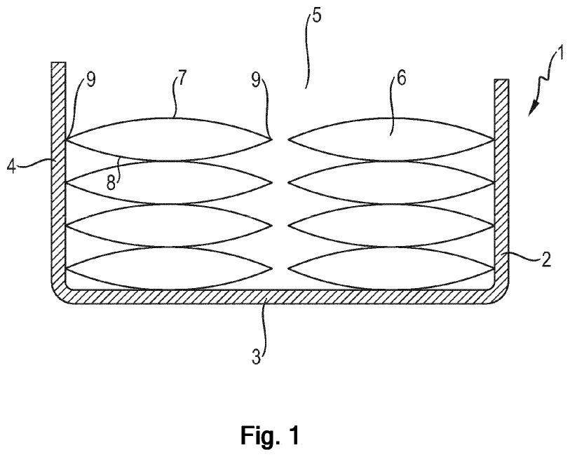

The multi-pack 1 according to FIG. 1 comprises a receiving container 2 which is dimensionally stable. The receiving container 2 is thus substantially not deformable in a non-destructive manner, but has a defined shape. It can be formed in particular of plastics material or cardboard.

In the shown embodiment, the receiving container 2 has a base 3 and side walls 4. The side walls 4 surround a removal opening 5, which can be closed by means of a lid (not shown).

Inside the receiving container 2, a number of cleaning agent sachets 6 are stacked on the base 3. The cleaning agent sachets 6 are pillow-shaped in the embodiment shown and each have an upper face 7 and a lower face 8, which is opposite the upper face 7. The cleaning agent sachets 6 are formed by two films, a first film forming the upper face 7 and a second film forming the lower face. In edge regions 9 of the cleaning agent sachets 6, the films are welded, glued, or glued and welded together.

Within the receiving container 2, the individual cleaning agent sachets 6 are arranged in like orientation, i.e. their upper faces 7 and lower faces 8 are each aligned substantially parallel to one another, all sachet upper faces 7 facing upward toward the removal opening 5 of the receiving container 2. A main plane of the cleaning agent sachets 6 is oriented parallel to the base 3. Furthermore, the sachets 6 are also aligned identically with respect to their lateral edge regions 9, so that in the present exemplary embodiment, the mutually corresponding lateral edge regions 9 of all sachets 6 rest one on top of the other within the receiving container 2.

For example, product information is imprinted on each of the upper faces 7 of the cleaning agent sachets 6. These imprints are not visible in the illustration in FIG. 1. Since the upper faces 7 of all cleaning agent sachets 6 are oriented toward the removal opening 5 and the sachet side edges are also aligned identically, the imprints are always easily legible.

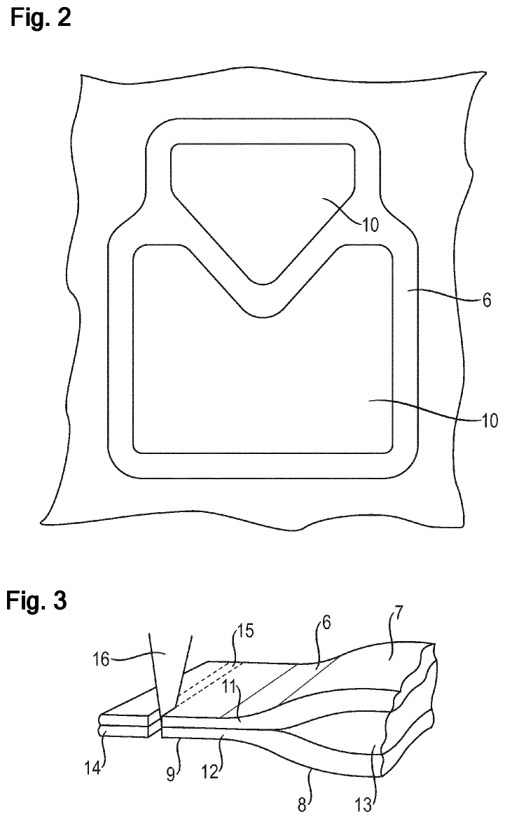

FIGS. 2 and 3 show intermediate products of a method for producing the multi-pack 1 having the cleaning agent sachets 6 according to an embodiment of the invention. The cleaning agent sachet 6 has, in the shown embodiment, two separate sachet chambers 10, which can contain, for example, different components of a cleaning agent.

As can be seen in cross section in FIG. 3, the cleaning agent sachet 6 comprises a second water-soluble film 12 and a first water-soluble film 11 arranged thereon, which films are sealed outside the sachet chambers 10 to form a film composite 14 and encompass a cleaning agent preparation 13 therebetween in the region of the sachet chamber 10.

In order to detach the cleaning agent sachet 6 from the film composite 14 surrounding it, said sachet is cut out along the contour 15 to form the edge regions 9. The cutting takes place, for example, by means of a laser beam 16, which is directed at the upper face of the film composite 14 and guided along the contour 15. If the laser beam 16 evaporates all the material of the film composite 14 along the contour 15, the cleaning agent sachet 6 is completely cut out of the film composite 14 surrounding it. It can then be picked up by means of a pick-and-place method and be stacked immediately in the receiving container 2 according to FIG. 1.

Alternatively, the cutting to separate the sachets can take place by means of rotating or axially guided blades or stationary blades. According to a further alternative, the separation of the cleaning agent sachets can also take place by punching.

### LIST OF REFERENCE NUMERALS

1 Multi-pack
2 Receiving container
3 Base
4 Side wall
5 Removal opening
6 Cleaning agent sachet
7 Upper face
8 Lower face
9 Edge region
10 Sachet chamber
11 First film
12 Second film
13 Cleaning agent preparation
14 Film composite
15 Contour
16 Laser beam

What is claimed is:

1. A multi-pack consisting of a dimensionally stable receiving container and a plurality of deformable cleaning agent sachets that are received in the receiving container, wherein the cleaning agent sachets are arranged in the receiving container in like orientation.

2. The multi-pack according to claim 1, wherein the receiving container comprises a base, wherein the cleaning agent sachets have at least one upper face and one lower face opposite the upper face, which faces from the main surfaces of the cleaning agent sachet, wherein the cleaning agent sachets—are aligned in the receiving container such that the upper faces and lower faces are aligned parallel to the base of the receiving container.

3. The multi-pack according to claim 2, wherein the cleaning agent for forming the cleaning agent sachets is received between a first film and a second film, wherein the first film in each case forms the upper face and the second film in each case forms the lower face of the cleaning agent sachets, and wherein the first film—and the second film are in each case interconnected in peripheral edge regions—of the cleaning agent sachets.

4. The multi-pack according to claim 1, wherein the cleaning agent sachet is formed by at least one water-soluble film.

5. The multi-pack according to claim 1, wherein the cleaning agent sachets are designed as multi-chamber sachets, in which a plurality of components of the cleaning agent are arranged separately from one another in chambers of the cleaning agent sachet.

6. A method for providing a multi-pack according to claim 1, wherein the method comprises the following:
providing a dimensionally stable receiving container;
providing a number of deformable cleaning agent sachets;
picking up and stacking the cleaning agent sachets in like orientation in the receiving container in an automated manner.

7. The method according to claim 6, wherein the step of providing a number of deformable cleaning agent sachets comprises encasing a number of cleaning agent portions using at least one common film and subsequently cutting the film to separate the cleaning agent sachets, wherein the automated picking up and stacking of the cleaning agent sachets in the receiving container takes place immediately after the separation of the cleaning agent sachets.
